(19) United States
(12) Patent Application Publication
(10) Pub. No.: US 2026/0228838 A1
(43) Pub. Date: Aug. 6, 2026

(54) ESTIMATION DEVICE, ESTIMATION SYSTEM, ESTIMATION METHOD, AND NON-TRANSITORY RECORDING MEDIUM

(71) Applicant: NEC Corporation, Tokyo (JP)

(72) Inventor: Toshiro YAMAMOTO, Tokyo (JP)

(73) Assignee: NEC Corporation, Tokyo (JP)

(21) Appl. No.: 19/154,819

(22) PCT Filed: Feb. 20, 2023
(86) PCT No.: PCT/JP2023/005957

§ 371 Date: Aug. 8, 2025

(51) Int. Cl. G06Q 50/12; G06Q 10/02

(52) U.S. Cl. CPC G06Q 50/12; G06Q 10/028

(57) ABSTRACT

An estimation device according to the present disclosure including, a progress acquisition unit that acquires progress information indicating the meal progress status for a customer who is using a table in a restaurant, an action acquisition unit that acquires action information indicating action of the customer an estimation unit that estimates, on the basis of the progress information and the action information, leaving estimation time, which is the time until the customer leaves the restaurant and an output unit that outputs an estimation result having been estimated.

### TECHNICAL FIELD

The present disclosure relates to an estimation device, an estimation system, an estimation method, and a recording medium.

### BACKGROUND ART

There is a technology for estimating and displaying a real-time seat availability and waiting time in a restaurant.

For example, PTL 1 discloses calculating an estimated seat usage time by each user based on data regarding a remaining amount of food obtained by image recognition. PTL 2 discloses a method of estimating an estimated location leaving time of a customer by correcting a staying time of the customer estimated based on information regarding an attribute of the customer based on information regarding a pace at which the customer eats and drinks.

### CITATION LIST

### Patent Literature

PTL 1: JP 2019-003361 A

PTL 2: JP 2022-041715 A

### SUMMARY OF INVENTION

### Technical Problem

In the techniques disclosed in PTLs 1 and 2, the estimated location leaving time is estimated based on the customer's meal status, but the estimated location leaving time may change due to other factors.

An object of the present disclosure is to provide an estimation device capable of further improving estimation accuracy of an estimated location leaving time.

### Solution to Problem

An estimation device according to one aspect of the present disclosure includes a progress acquisition means for acquiring progress information indicating a progress status of a meal of a customer who is using a seat in a location, a motion acquisition means for acquiring motion information indicating a motion of the customer, an estimation means for estimating an estimated location leaving time until the customer leaves the location based on the progress information and the motion information, and an output means for outputting an estimated estimation result.

An estimation system according to another aspect of the present disclosure includes the estimation device described above, and an imaging device installed at a position where a motion of a customer who is using a seat in a location can be imaged, in which the motion acquisition means acquires motion information indicating a motion of the customer by analyzing an image captured by the imaging device.

An estimation method according to still another aspect of the present disclosure causes a computer to execute processing of acquiring progress information indicating a progress status of a meal of a customer who is using a seat in a location, acquiring motion information indicating a motion of the customer, estimating an estimated location leaving time until the customer leaves the location based on the progress information and the motion information, and outputting an estimated estimation result.

A recording medium according to further aspect of the present disclosure, stores a program for causing a computer to execute processing of acquiring progress information indicating a progress status of a meal of a customer who is using a seat in a location, acquiring motion information indicating a motion of the customer, estimating an estimated location leaving time until the customer leaves the location based on the progress information and the motion information, and outputting an estimated estimation result.

### Advantageous Effects of Invention

According to the present disclosure, it is possible to provide an estimation device capable of further improving estimation accuracy of an estimated location leaving time.

### BRIEF DESCRIPTION OF DRAWINGS

FIG. 1 is a block diagram illustrating a configuration example including an estimation device according to a first example embodiment.

FIG. 2 is a diagram illustrating a hardware configuration in which the estimation device according to the first example embodiment is implemented by a computer device and its peripheral device.

FIG. 3 is a diagram illustrating an example of a usage scene in the first example embodiment.

FIG. 4 is an example of output of an estimated location leaving time by an output unit according to the first example embodiment.

FIG. 5 is a flowchart illustrating an operation of the estimation device according to the first example embodiment.

FIG. 6 is a block diagram illustrating a configuration example including an estimation device according to a second example embodiment.

FIG. 7 is a flowchart illustrating an operation of the estimation device according to the second example embodiment.

FIG. 8 is a flowchart illustrating an operation of an estimation device in a modification of the second example embodiment.

### EXAMPLE EMBODIMENT

Hereinafter, example embodiments of an estimation device, an estimation system, an estimation method, and a non-transitory recording medium recording a program according to the present disclosure will be described in detail with reference to the drawings. The present example embodiments do not limit the disclosed technology.

### First Example Embodiment

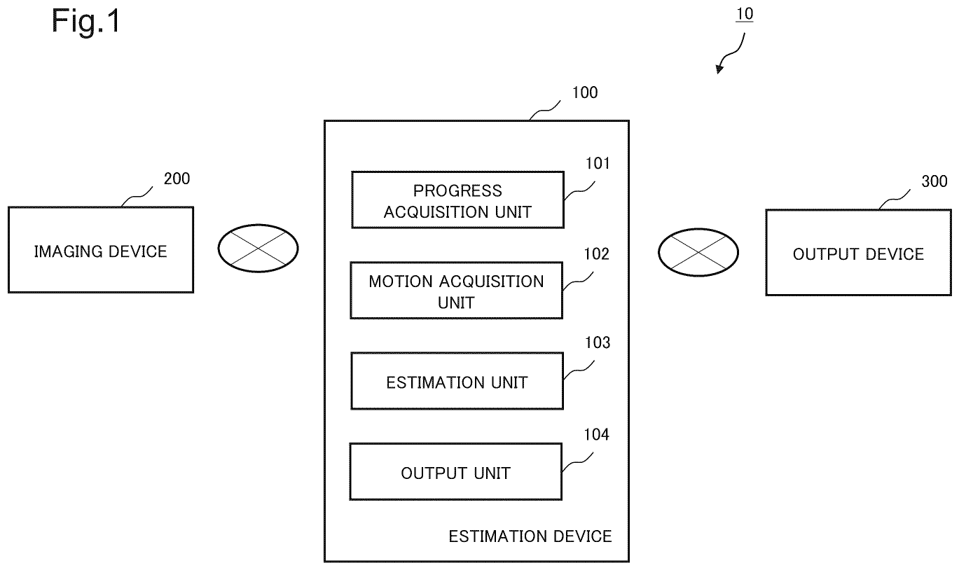

First, a first example embodiment of the present disclosure will be described in detail with reference to the drawings. FIG. 1 is a block diagram illustrating an example of a configuration of an estimation device 100 in an estimation system 10 according to the first example embodiment. In the estimation system 10, an estimation device 100 is connected via a network to an imaging device 200 installed at a position where a motion of a customer using a seat in a location can be imaged and an output device 300 that outputs an estimation result.

The estimation device 100 is a device for estimating an estimated location leaving time of a customer having a meal in a location of a restaurant. The invention of the present disclosure can be applied to all restaurants, but in particular, a restaurant that stays for purposes other than meals such as a cafe or a family restaurant is assumed.

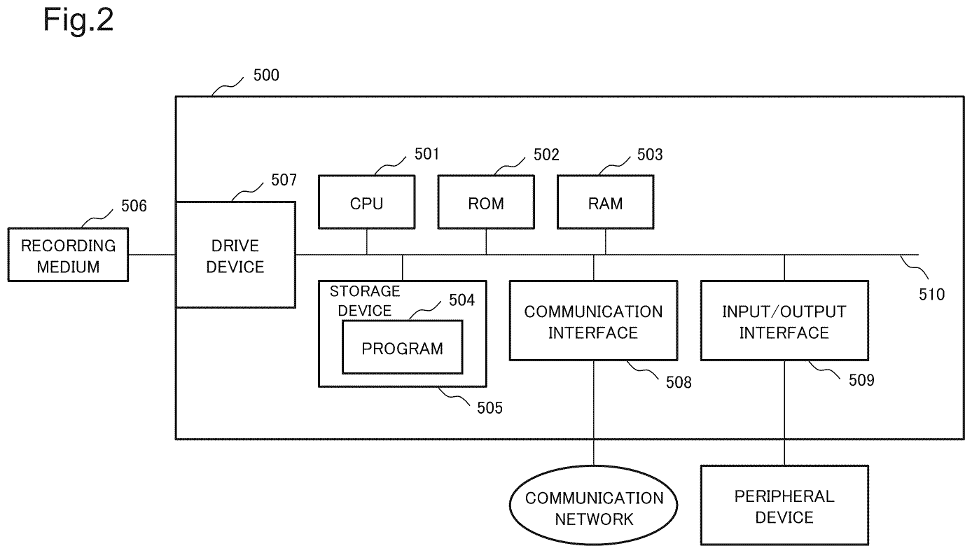

Referring to FIG. 1, the estimation device 100 includes a progress acquisition unit 101, a motion acquisition unit 102, an estimation unit 103, and an output unit 104. FIG. 2 is a diagram illustrating an example of a hardware configuration in which the estimation device 100 according to the first example embodiment of the present disclosure is implemented by a computer device 500 including a processor. As illustrated in FIG. 2, the estimation device 100 includes a memory such as a central processing unit (CPU) 501, a read only memory (ROM) 502, and a random access memory (RAM) 503, a storage device 505 such as a hard disk that stores a program 504, a communication interface 508 for network connection, and an input/output interface 509 that inputs and outputs data. In the first example embodiment, the estimation device 100 is connected to each component via a bus 510. Furthermore, the estimation device 100 according to the first example embodiment illustrated in FIG. 1 can also be configured by cloud computing or the like.

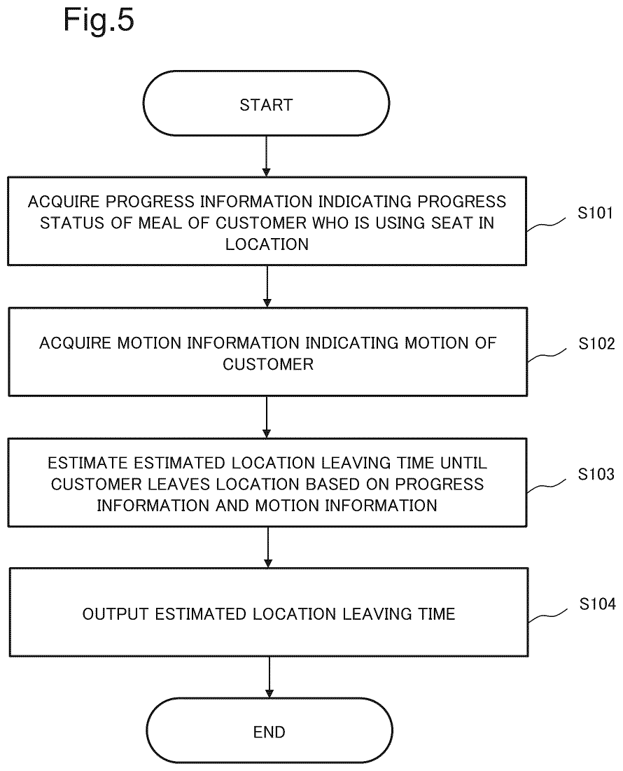

The CPU 501 operates an operating system to control the entire estimation device 100 according to the first example embodiment of the present invention. In addition, the CPU 501 reads programs and data from a recording medium 506 mounted in, for example, a drive device 507 or other device onto a memory. In addition, the CPU 501 functions as the progress acquisition unit 101, the motion acquisition unit 102, the estimation unit 103, the output unit 104, and a part thereof in the first example embodiment, and executes processing or a command in a flowchart illustrated in FIG. 5 to be described later based on a program.

Examples of the recording medium 506 include an optical disc, a flexible disk, a magnetic optical disc, an external hard disk, and a semiconductor memory. A semiconductor memory or other memory, which is one of recording media, is a non-volatile storage device and records programs therein. The programs may be downloaded from an external computer (not illustrated) connected to a communication network.

As described above, the first example embodiment illustrated in FIG. 1 is implemented by the computer hardware illustrated in FIG. 2. However, a means for achieving each unit included in the estimation device 100 in FIG. 1 is not limited to the above-described configuration. Furthermore, the estimation device 100 may be achieved by one physically coupled device, or may be achieved by a system including equal to or more than two physically separated devices connected by wire or wirelessly and including the plurality of devices.

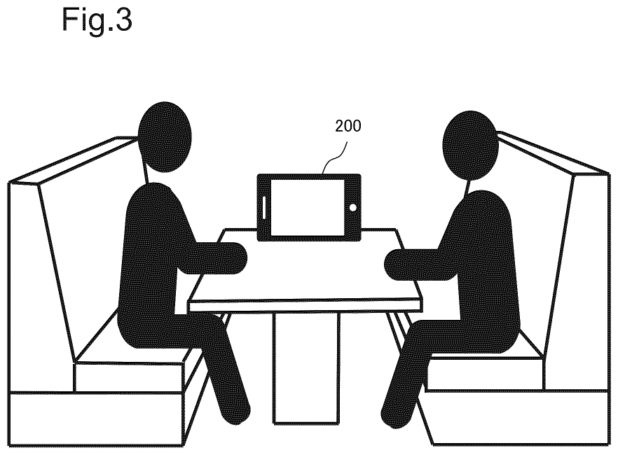

FIG. 3 is a diagram illustrating an example of a usage scene of the present example embodiment. In the present example embodiment, after a customer enters a location, an employee inputs a table number and customer information such as information indicating an age group, the number of people, or a relationship between customers to a point of sale (POS) terminal, and starts a tablet terminal placed on a table. The tablet terminal includes an imaging device 200, and acquires an image obtained by imaging a status of the table of the customer and the motion of the customer. In a case where the tablet terminal has an image analysis function, the customer information described above may be automatically input by analyzing an image captured by the imaging device 200. The menu information ordered by the customer with the tablet terminal is stored in the POS terminal through the network.

The progress acquisition unit 101 is a means that acquires progress information indicating the progress status of the meal of the customer who is using the seat in the location. In the present example embodiment, the progress information includes information that allows the progress of the order and the meal to be grasped. The progress information may include at least one of information about a remaining amount of a meal placed on the table of the customer, an ordered item category, the number of ordered items, and a staying time. The progress acquisition unit 101 acquires the remaining amount of food placed on the table of the customer and the order item category by analyzing the image obtained by imaging the table of the customer by the imaging device 200. Further, the progress acquisition unit 101 acquires the number of ordered items and the staying time from the POS terminal. However, the method of acquiring these pieces of information is not limited to the above-described example.

For example, the progress acquisition unit 101 analyzes the image acquired from the imaging device 200, identifies the presence or absence of dishes and the remaining amount of food of the meal on the table, and acquires the progress status of the meal by the image in a case where the finish of meal is 100%. The progress acquisition unit 101 may analyze how the food is reduced from the image, and may regard that the food is finished if the food is not reduced for a predetermined time or more. Furthermore, the progress acquisition unit 101 may estimate the progress status of the meal from the staying time based on, for example, an average staying time for each attribute. In addition, the progress acquisition unit 101 acquires the progress status of the order based on, for example, the number of ordered items or the ordered item category. The order item category is a category in which a progress status of an order such as an appetizer, a main dish, and a sweet dish can be grasped. For example, the progress acquisition unit 101 acquires the progress status from the number of ordered items based on the average number of ordered items for each attribute. The progress acquisition unit 101 outputs the progress information acquired in this manner to the estimation unit 103.

The motion acquisition unit 102 is a means that acquires motion information indicating the motion of the customer. In the present example embodiment, the state of the customer is a current motion of the customer, such as eating, drinking, drowsy, working on a PC, reading, talking, or wearing an outerwear. The motion acquisition unit 102 acquires the image by analyzing the image obtained by imaging the customer by the imaging device 200 such as the tablet terminal or a security camera device in the location. For example, the motion acquisition unit 102 reads, from the storage device 505, a motion analysis rule in which a posture and a motion pattern of the customer extracted from the feature of the image are associated with each other, and acquires the motion of the customer. In a case where personal belongings such as a PC, a book, and an outerwear are included in the image, the motion of the customer may be analyzed based on the personal belongings. In addition, the motion acquisition unit 102 may exclude the estimated location leaving time of the customer from the estimation target when the same motion is performed for a long time and the accurate estimated location leaving time cannot be estimated. However, the method by which the motion acquisition unit 102 acquires the motion information about the customer is not limited to the above-described method. The motion acquisition unit 102 outputs the acquired motion information to the estimation unit 103.

The estimation unit 103 is a means that estimates an estimated location leaving time until the customer leaves the location based on the progress information and the motion information. Specifically, the estimation unit 103 estimates a time until the meal is finished based on the progress information, and corrects the estimated location leaving time of the customer based on the motion information about the customer. For example, in a case where a customer intends to start working or is working on a PC or the like even when the customer finishes eating, the estimation unit 103 estimates the estimated location leaving time in consideration of the staying time for working on the PC. The estimation device 100 stores, in the storage device 505, information about an average staying time during which the customer who has started each motion stays, and the estimation unit 103 estimates the estimated location leaving time based on the average staying time. On the other hand, even if the meal placed on the table of the customer remains, in a case where the customer prepares to leave the location by wearing an outerwear, the estimation unit 103 shortens the estimated location leaving time to, for example, 0 to 5 minutes.

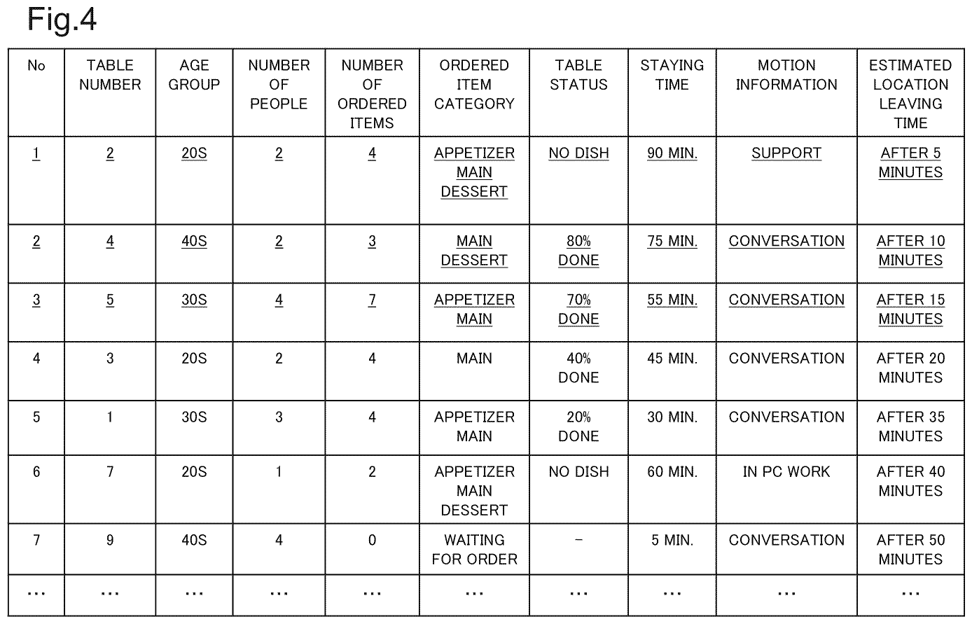

The output unit 104 is a means that outputs an estimated estimation result. In the present example embodiment, the output unit 104 outputs the estimated location leaving time. The output unit 104 displays the estimated location leaving time on the output device 300 such as a display installed in a backyard of the location. FIG. 4 shows an example of output of the estimated location leaving time by the output unit 104 in the present example embodiment. As illustrated in FIG. 4, the estimated location leaving time is associated with the table number, the customer information about the age group and the number of people, the progress information about the number of ordered items, the ordered item category, the table status and the staying time, and the motion information, and the estimated location leaving time is sorted and output in order of early location leaving time. In the example of FIG. 4, for example, the estimation unit 103 estimates that a customer No. 6 has no dish and has finished eating, but estimates that the estimated time to leave the location is 40 minutes later because the customer works with a PC.

The output unit 104 may change an output mode of the estimated location leaving time based on the accuracy of the estimated location leaving time estimated by the estimation unit 103. Examples of the output mode include changing a color or a size of a character, highlighting, and the like. For example, the output unit 104 may highlight information in which the estimated location leaving time is within a predetermined time or the estimated location leaving time is within a predetermined order in a mode different from other waiting times. In the example of FIG. 4, information indicating that the estimated location leaving time is within 15 minutes is underlined.

FIG. 5 is a flowchart illustrating an outline of the operation of the estimation device 100 according to the first example embodiment. Processing according to this flowchart may be performed based on program control executed by the processor described above. This flow is executed, for example, when an instruction for estimating the estimated location leaving time of the customer in the location is given to the estimation device 100.

As illustrated in FIG. 5, first, the progress acquisition unit 101 acquires progress information indicating the progress status of the meal of the customer who is using the seat in the location (step S101). Next, the motion acquisition unit 102 acquires motion information indicating the motion of the customer (step S102). Next, the estimation unit 103 estimates an estimated location leaving time until the customer leaves the location based on the progress information and the motion information (step S103). Finally, the output unit 104 outputs the estimated location leaving time that has been estimated (step S104). Thus, the estimation device 100 ends the estimation processing.

In the estimation device 100 according to the present example embodiment, the estimation unit 103 estimates the estimated location leaving time until the customer leaves the location based on the progress information and the motion information. The output unit 104 also outputs the estimated location leaving time that has been estimated. As a result, for example, the estimated location leaving time is estimated in consideration of a case where there is a possibility of staying as it is even when the eating is finished. Therefore, according to the estimation device 100, the estimation accuracy of the estimated location leaving time can be further improved.

### Modification of First Example Embodiment

In the first example embodiment described above, the estimation unit 103 estimates the estimated location leaving time until the customer leaves the location based on the progress information and the motion information. The estimation unit 103 may further estimate the estimated location leaving time based on the customer information or the location business category. The customer information is information indicating the age group, sex, and number of customers, or a relationship between customers such as a family, a work relationship, or a friend. For example, the estimation unit 103 acquires the customer information from the POS terminal. The estimation unit 103 estimates the estimated location leaving time based on the customer information by a known method. For example, the estimation unit 103 acquires the customer information, and estimates the estimated location leaving time based on the average staying time recorded for each age group or sex. In addition, in a case where a predetermined number of people or more visit the location, the estimation unit 103 may estimate the estimated location leaving time longer than the average staying time.

Furthermore, the estimation unit 103 acquires, from the POS terminal, information indicating a business category of the location, such as morning, lunch, or dinner. For example, the estimation unit 103 may estimate the estimated location leaving time of the customer who visits the location at lunch time to be shorter than the estimated location leaving time of the customer who visits the location at dinner time.

### Second Example Embodiment

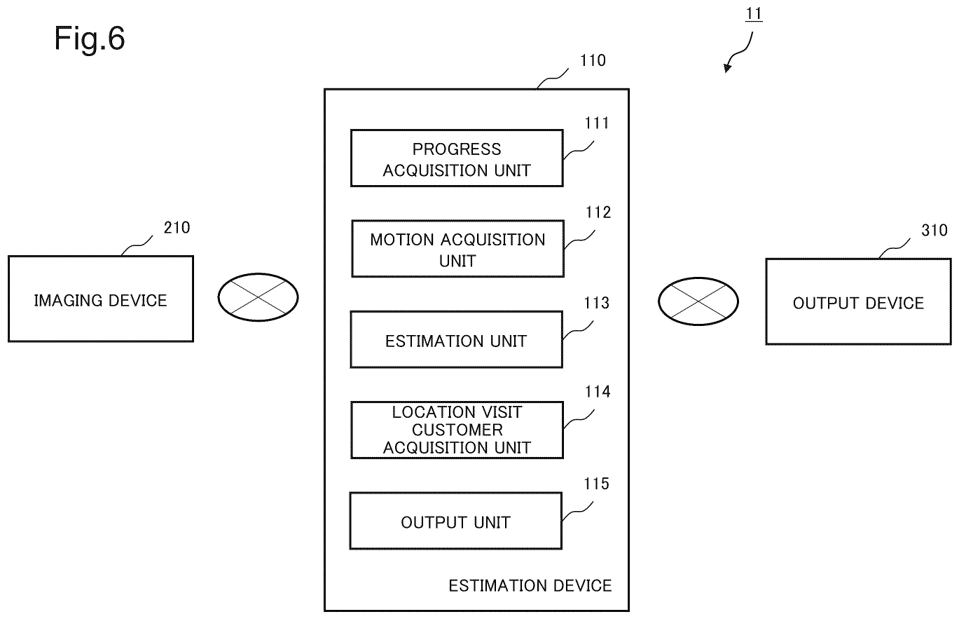

Next, a second example embodiment of the present disclosure will be described in detail with reference to the drawings. FIG. 6 is a diagram illustrating a block diagram of an estimation system 11 including an estimation device 110 according to a second example embodiment. The present example embodiment assumes a case where the location is full and waiting in line occurs at the time of entering the location.

Hereinafter, description of contents overlapping with the above description will be omitted to the extent that the description of the present example embodiment is not unclear. As in the computer device illustrated in FIG. 2, each component in each example embodiment of the present disclosure can be achieved not only by hardware but also by a computer device or software based on program control.

The estimation device 110 according to the present example embodiment includes a progress acquisition unit 111, a motion acquisition unit 112, an estimation unit 113, a location visit customer acquisition unit 114, and an output unit 115. That is, the estimation device 110 is at least different from the estimation device 100 in including the location visit customer acquisition unit 114. The progress acquisition unit 111 and the motion acquisition unit 112 in the present example embodiment are similar to the configurations of the progress acquisition unit 101 and the motion acquisition unit 102 in the first example embodiment.

The location visit customer acquisition unit 114 is a means for acquiring information about a location entering order of the location visit customers when the location is full. For example, when a customer who has come to the location receives entry from a ticket machine installed at a location entrance, the location visit customer acquisition unit 114 acquires information indicating a location entering order. In addition, the ticket machine issues a number tag indicating a location entering order to the customer. In addition, in a case where a location entry reservation can be made on an application program of the location, the location visit customer acquisition unit 114 may acquire information indicating the location entering order when accepting the location entry reservation of the location visit customer. The location visit customer acquisition unit 114 outputs the location entering order information to the estimation unit 113.

In addition to the function of the first example embodiment, the estimation unit 113 estimates a waiting time of the customer based on the estimated location leaving time of the customer with the location leaving order associated with the location entering order in a case where the customers who are using the location are sorted in order of the earliest estimated location leaving time. That is, for example, in a case where the location entering order input from the location visit customer acquisition unit 114 is the first, the estimation unit 113 estimates the estimated location leaving time of the customer with the first order of location leaving in a case where the customers who are using the location are sorted in order of earliest estimated location leaving time as the waiting time of the location visit customer. Similarly, for example, in a case where the location entering order input from the location visit customer acquisition unit 114 is second, the estimation unit 113 estimates the estimated location leaving time of the customer with the second order of location leaving in a case where the customers who are using the location are sorted in order of earliest estimated location leaving time as the waiting time of the customer. Further, the estimation unit 113 may set, as the waiting time, a time obtained by adding a predetermined time to the estimated location leaving time that has been estimated. The predetermined time to be added may be an average time required for the employee to clear the table after the customer leaves the location.

The output unit 115 outputs the waiting time. For example, in the example of FIG. 4, the output unit 115 notifies the customer who waits first to enter the location that the waiting time is 5 minutes based on the estimated location leaving time of the customer whose order of leaving the location is the first, which is 5 minutes or later. Similarly, the output unit 104 notifies the customer who waits second to enter the location that the waiting time is 10 minutes based on the estimated location leaving time of the customer whose order of leaving the location is the second, which is 10 minutes or later. The output unit 115 may change the output mode of the waiting time based on the accuracy of the waiting time estimated by the estimation unit 113. Examples of the output mode include changing a color or a size of a character, highlighting, and the like. For example, the output unit 115 may highlight a waiting time within a predetermined time in a color or the like different from other waiting times.

For example, the output unit 115 may output the waiting time of the location visit customer together with the location entering order to a number tag issued by the ticket machine to the customer, or may output a list of waiting times in association with the number tag to the output device 310 installed in the location. The output unit 115 may output the waiting time of the location visit customer together with the location entering order on an application program.

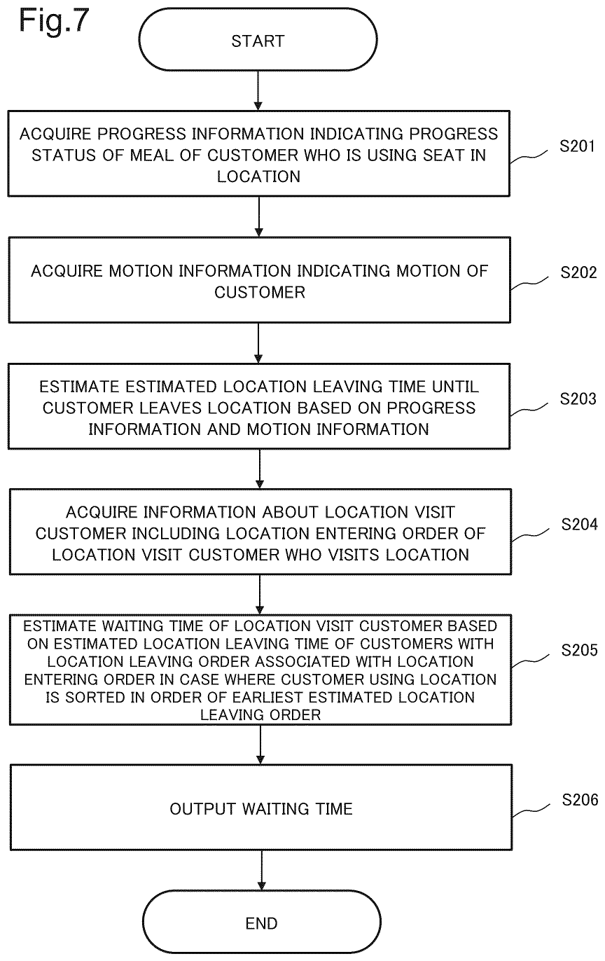

FIG. 7 is a flowchart illustrating an outline of the operation of the estimation device 110 according to the second example embodiment. Processing according to this flowchart may be performed based on program control executed by the processor described above. For example, in a case where the inside of the location is full, the processing by this flow is executed when the waiting time until the location entry of the location visit customer is estimated.

As illustrated in FIG. 7, first, the progress acquisition unit 111 acquires progress information indicating the progress status of the meal of the customer who is using the seat in the location (step S201). Next, the motion acquisition unit 112 acquires motion information indicating the motion of the customer (step S202). Next, the estimation unit 113 estimates an estimated location leaving time until the customer leaves the location based on the progress information and the motion information (step S203). Next, the location visit customer acquisition unit 114 acquires information about location visit customers including information about the location entering order of the location visit customers (step S204). Next, the estimation unit 113 estimates the waiting time of the location visit customer based on the estimated location leaving time of the customers with the location leaving order associated with the location entering order in a case where the customers who are using the location are sorted in order of the earliest estimated location leaving time (step S205). Finally, the output unit 115 outputs the waiting time (step S206). Thus, the estimation device 110 ends the estimation processing.

In the present example embodiment, the estimation unit 113 estimates the waiting time of the location visit customer based on the estimated location leaving time of the customers with the location leaving order associated with the location entering order in a case where the customers who are using the location are sorted in order of the earliest estimated location leaving time. The output unit 115 outputs the waiting time of the customer. As a result, it is possible to notify the customer who visits the location when the location is full of the waiting time estimated based on the estimated location leaving time with high estimation accuracy.

### Modification of Second Example Embodiment

Next, a modification of the second example embodiment of the present disclosure will be described focusing on differences from the second example embodiment. In the present modification, in a case where the location is full, it is estimated whether the customer who has come to the location can meet the scheduled schedule even if the customer eats at the location. In the present modification, the location visit customer acquisition unit 114 further acquires information about a desired location leaving time of the location visit customer as the information about the location visit customer. In the present modification, it is assumed that the storage device 505 stores biometric authentication information about the customer and boarding information about a transportation system that the customer is scheduled to board in association with the customer ID.

The location visit customer acquisition unit 114 acquires information about the desired location leaving time of the location visit customer. The desired location leaving time is a time at which the customer has to finish eating at the location and leave the location in order to meet the scheduled schedule. For example, when the location visit customer accepts entry from a ticket machine installed at a location entrance, the location visit customer acquisition unit 114 accepts input of information about a desired location leaving time, and acquires the information. In addition, in a case where the location entry reservation can be made on the application program of the location, the location visit customer acquisition unit 114 may receive the input of the information about the desired location leaving time and acquire the information when receiving the location entry reservation. In addition, the location visit customer acquisition unit 114 may acquire the menu information in the case of accepting the input of the menu information ordered by the location visit customer together with the desired location leaving time when the location visit customer accepts the entry or reserves the entry.

The location visit customer acquisition unit 114 may calculate the desired location leaving time based on, for example, schedule information about the location visit customer. In this case, for example, the location visit customer acquisition unit 114 may acquire schedule information stored in a terminal possessed by the location visit customer. The schedule information includes a place where the user is scheduled to go and a scheduled time of the place. The location visit customer acquisition unit 114 calculates a desired location leaving time at which the user can arrive at a place scheduled to go at a scheduled time using a known method.

For example, when the schedule information is boarding on a transportation system, the location visit customer acquisition unit 114 acquires the schedule information by reading the boarding information stored in a ticket. Specifically, for example, a two-dimensional code in which information about a place where the user is scheduled to board a transportation system such as an airplane, a train, or a bus and information that can identify a departure time are stored is printed on a ticket, and the location visit customer acquisition unit 114 acquires schedule information by reading the two-dimensional code with a reading device provided in a ticket machine or the like. In the present example embodiment, in a case where the location is a restaurant in the airport and the transportation system is an airplane, the two-dimensional code may store information that can identify closing times of a boarding gate and a safety inspection site.

Further, in a case where the boarding information and the biometric authentication information are associated with each other, the location visit customer acquisition unit 114 reads the biometric authentication information about the location visit customer, and acquires the boarding information associated with the customer ID of the location visit customer from the storage device 505. The biometric authentication information is not particularly limited, and may be any biometric authentication information capable of identifying a location visit customer, such as face authentication information, iris authentication information, fingerprint authentication information, or vein authentication information. When acquiring the face authentication information, for example, the location visit customer acquisition unit 114 acquires data of the feature amount of a face of the location visit customer from an image captured by an imaging device provided in a ticket machine or the like. Next, the location visit customer acquisition unit 114 identifies a customer ID matching the feature amount data of the face of the location visit customer from the storage device 505, and acquires the boarding information associated with the customer ID. However, a means for identifying the customer ID is not limited thereto.

In addition to the functions of the first and second example embodiments, the estimation unit 113 estimates whether it is in time for the desired location leaving time based on the waiting time of the location visit customer and the scheduled staying time in the location. The estimation unit 113 acquires the waiting time by a method similar to that of the estimation unit 113 in the second example embodiment. Furthermore, the estimation unit 113 estimates the scheduled staying time of the location visit customer at the location based on the average staying time. The average staying time is stored in the storage device 505 in association with the number of customers or attributes, for example. Next, the estimation unit 113 estimates whether it is in time for the desired location leaving time depending on whether a time at which the waiting time and the scheduled staying time at the location have elapsed from the current time is before or after the desired location leaving time.

In a case where the location visit customer acquisition unit 114 has acquired the menu information ordered by the location visit customer, the estimation unit 113 may perform estimation using an average value of the food serving time and the meal time for each menu instead of the average staying time. In the present example embodiment, a known method is used as a method of acquiring the food serving time and the meal time for each menu. For example, a food serving time is a time from a time at which an order is placed at the POS terminal to a time at which the ordered food is provided to the table, and the provision of the food is detected by analyzing an image of the table captured by the imaging device 210. In addition, the meal time is a time from the serving time at which the ordered dish is provided to the table until there is no leftover of food, and it is detected by analyzing the image of the dish that there is no leftover of food. The average value of the food serving time and the meal time thus acquired is stored in the storage device 505 in association with the menu name.

Furthermore, the estimation unit 113 may estimate menu information in time for the desired location leaving time. The estimation unit 113 sets a time obtained by subtracting the waiting time from the time until the desired location leaving time as an available staying time, and estimates menu information that can be ordered with the available staying time by using an average value of the food serving time and the meal time associated with each menu. An average value of meal times may be calculated for each attribute such as sex and age group.

The output unit 115 outputs an estimation result as to whether it is in time for the desired location leaving time. In addition, in a case where menu information in time for the desired location leaving time is estimated, the output unit 115 may output the menu information.

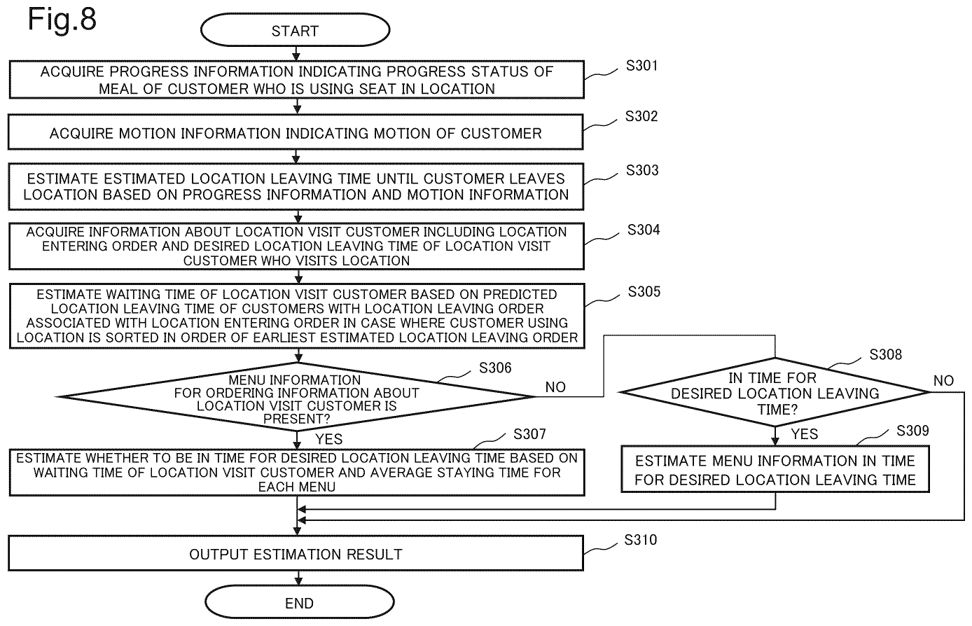

FIG. 8 is a flowchart illustrating an outline of an operation of the estimation device 110 in a modification of the second example embodiment. Processing according to this flowchart may be performed based on program control executed by the processor described above.

As illustrated in FIG. 8, first, the progress acquisition unit 111 acquires progress information indicating the progress status of the meal of the customer who is using the seat in the location (step S301). Next, the motion acquisition unit 112 acquires motion information indicating the motion of the customer (step S302). Next, the estimation unit 113 estimates an estimated location leaving time until the customer leaves the location based on the progress information and the motion information (step S303). Next, the location visit customer acquisition unit 114 acquires information regarding the location visit customer including the location entering order and the desired location leaving time of the location visit customer (step S304). Next, the estimation unit 203 estimates the waiting time of the location visit customer based on the estimated location leaving time of the customers with the location leaving order associated with the location entering order in a case where the customers who are using the location are sorted in order of the earliest estimated location leaving time (step S305). Next, in a case where the location visit customer acquisition unit 114 has received the ordered menu information (step S306; YES), the estimation unit 113 estimates whether it is in time for the desired location leaving time based on the waiting time of the location visit customer and the average staying time for each menu (step S307). On the other hand, when the location visit customer acquisition unit 114 has not received the ordered menu information to be ordered (S306; NO), the estimation unit 113 estimates whether it is in time for the desired location leaving time based on the waiting time of the location visit customer and the average staying time of the location (step S308). In a case of estimating that it is time for the desired location leaving time (S308; YES), the estimation unit 113 estimates menu information in time for the desired location leaving time (step S309). In a case where the estimation unit 113 estimates that it will not be in time for the desired location leaving time (S308; NO), the flow proceeds to step S310. Finally, the output unit 115 outputs the estimation result (step S310). Thus, the estimation device 110 ends the processing.

In the present example embodiment, the location visit customer acquisition unit 114 further acquires information about the desired location leaving time of the location visit customer, and the estimation unit 113 estimates whether it is in time for the desired location leaving time based on the waiting time of the location visit customer, and the scheduled staying time in the location. As a result, the location visit customer can grasp whether it is in time for the planned schedule even if the customer has a meal at the location. Furthermore, in the present example embodiment, in the case of receiving menu information to be ordered from the location visit customer, the estimation unit 113 estimates whether it is in time for the desired location leaving time based on the waiting time of the location visit customer and the average staying time for each menu. As a result, even if the location visit customer requests a menu that the customer wants to eat, it is possible to grasp whether the customer can meet the planned schedule. Furthermore, in a case where the menu information to be ordered has not been accepted, the estimation unit 113 estimates the menu information in time for the desired location leaving time. As a result, if the location visit customer orders the menu, the location visit customer can meet the planned schedule even if the customer has a meal at the location.

While the present disclosure has been particularly shown and described with reference to example embodiments thereof, the present disclosure is not limited to these example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content. For example, in a modification of the second example embodiment, the output unit 115 may display a list of average meal times of each menu for each attribute of the customer. In this case, for example, the employee of the location can prompt the location to review the menu, such as stopping providing the lunch time for which the rotation rate is desired to be increased, for the menu for which the average meal time is longer than or equal to a predetermined time.

Some or all of the above example embodiments can also be described as the following Supplementary Notes. However, some or all of the above example embodiments are not limited to the following.

### (Supplementary Note 1)

An estimation device including:
indicating a progress status of a meal of a customer who is using a seat in a location;
a motion acquisition means for acquiring motion information indicating a motion of the customer;
an estimation means for estimating an estimated location leaving time until the customer leaves the location based on the progress information and the motion information, and
an output means for outputting an estimated estimation result.

### (Supplementary Note 2)

The estimation device according to Supplementary Note 1, in which the progress acquisition means acquires the progress information about at least one of a remaining amount of food placed on a table of the customer, an ordered item category, a number of ordered items, and a staying time.

(supplementary Note 3)

The estimation device according to Supplementary Note 1 or 2, in which the estimation means further estimates a time until the customer leaves the location based on customer information.

### (Supplementary Note 4)

The estimation device according to any one of Supplementary Notes 1 to 3, in which the estimation means further estimates a time until the customer leaves the location based on information indicating a business category of the location.

(supplementary Note 5)

The estimation device according to any one of Supplementary Notes 1 to 4, further including a location visit customer acquisition means for acquiring information about a location visit customer including information about a location entering order of the location visit customers when the location is full, in which
the estimation means estimates a waiting time of the location visit customer based on the estimated location leaving time of the customer with the location leaving order associated with the location entering order in a case where the customers who are using the location are sorted in order of the earliest estimated location leaving time, and
the output means outputs the waiting time as the estimation result.

### (Supplementary Note 6)

The estimation device according to Supplementary Note 5, in which
the location visit customer acquisition means further acquires information about a desired location leaving time of the location visit customer,
the estimation means estimates whether it is in time for the desired location leaving time based on the waiting time of the location visit customer and a scheduled staying time at the location, and
the output means outputs the estimation result.

### (Supplementary Note 7)

The estimation device according to Supplementary Note 6, in which
the location visit customer acquisition means further acquires menu information ordered by the location visit customer, and
the estimation means further estimates menu information in time for the desired location leaving time.
   (supplementary Note 8)

The estimation device according to Supplementary Note 6 or 7, in which the location visit customer acquisition means calculates the desired location leaving time based on schedule information about the location visit customer.

(supplementary Note 9)

The estimation device according to any one of Supplementary Notes 1 to 8, in which the output means changes an output mode of the estimation result based on accuracy of the estimated location leaving time estimated by the estimation means.

(supplementary Note 10)

An estimation system including: the estimation device according to any one of Supplementary Notes 1 to 9; and an imaging device installed at a position where a motion of a customer who is using a seat in a location can be imaged, in which
the motion acquisition means acquires motion information indicating a motion of the customer by analyzing an image captured by the imaging device.

### (Supplementary Note 11)

An estimation method for causing a computer to execute processing of:
acquiring progress information indicating a progress status of a meal of a customer who is using a seat in a location;
acquiring motion information indicating a motion of the customer;
estimating an estimated location leaving time until the customer leaves the location based on the progress information and the motion information; and
outputting an estimated estimation result.
   (supplementary Note 12)

A recording medium storing a program for causing a computer to execute processing of:
acquiring progress information indicating a progress status of a meal of a customer who is using a seat in a location;
acquiring motion information indicating a motion of the customer;
estimating an estimated location leaving time until the customer leaves the location based on the progress information and the motion information; and
outputting an estimated estimation result.

### REFERENCE SIGNS LIST

10, 11 estimation system
100, 110 estimation device
101, 111 progress acquisition unit
102, 112 motion acquisition unit
103, 113 estimation unit
104, 115 output unit
114 location visit customer acquisition unit
200, 210 imaging device
300, 310 output device
500 computer device
501 CPU
502 ROM
503 RAM
504 program
505 storage device
506 recording medium
507 drive device
508 communication interface
509 input/output interface
510 bus

What is claimed is:

1. An estimation device comprising:
one or more memories storing instructions; and
one or more processors configured to execute the instructions to:
acquire progress information indicating a progress status of a meal of a customer who is using a seat in a location;
acquire motion information indicating a motion of the customer;
estimated location leaving time until the customer leaves the location based on the progress information and the motion information; and
output an estimated result.

2. The estimation device according to claim 1, wherein the one or more processors are further configured to execute the instructions to acquire the progress information including at least one of information about a remaining amount of food placed on a table of the customer, an ordered item category, a number of ordered items, and a staying time.

3. The estimation device according to claim 1, wherein the one or more processors are further configured to execute the instructions to estimate a time until the customer leaves the location based on customer information.

4. The estimation device according to claim 1, wherein the one or more processors are further configured to execute the instructions to estimate a time until the customer leaves the location based on information indicating a business category of the location.

5. The estimation device according to claim 1,
wherein the one or more processors are further configured to execute the instructions to:
acquire information about a location visit customer including information about a location entering order of the location visit customers when the location is full;
estimate a waiting time of the location visit customer based on the estimated location leaving time of a customer whose location leaving order number is the same as the location entering order number of the location visit customers, in a case where the customers who are using the location are sorted in order of the earliest estimated location leaving time; and
output the waiting time as the estimated result.

6. The estimation device according to claim 5,
wherein the one or more processors are further configured to execute the instructions to:
acquire information about a desired location leaving time of the location visit customer;
estimate whether it is in time for the desired location leaving time based on the waiting time of the location visit customer and a scheduled staying time at the location; and output the estimated result.

7. The estimation device according to claim 6,
wherein the one or more processors are further configured to execute the instructions to:
acquire menu information ordered by the location visit customer; and
estimate menu information in time for the desired location leaving time.

8. The estimation device according to claim 6, wherein the one or more processors are further configured to execute the instructions to calculate the desired location leaving time based on schedule information about the location visit customer.

9. The estimation device according to claim 1, wherein the one or more processors are further configured to execute the instructions to change an output mode of the estimated result based on accuracy of the estimated location leaving time.

10. An estimation system comprising:
an imaging device installed at a position where a motion of a customer who is using a seat in a location can be imaged; and
the estimation device according to claim 1, wherein the one or more processors are further configured to execute the instructions to acquire motion information indicating a motion of the customer by analyzing an image captured by the imaging device.

11. An estimation method for causing a computer to execute processing of:
acquiring progress information indicating a progress status of a meal of a customer who is using a seat in a location;
acquiring motion information indicating a motion of the customer;
estimating an estimated location leaving time until the customer leaves the location based on the progress information and the motion information; and
outputting an estimated result.

12. A non-transitory recording medium storing a program for causing a computer to execute processing of:
acquiring progress information indicating a progress status of a meal of a customer who is using a seat in a location;
acquiring motion information indicating a motion of the customer;
estimating an estimated location leaving time until the customer leaves the location based on the progress information and the motion information; and
outputting an estimated estimation result.
